(19) United States
(12) Patent Application Publication
(10) Pub. No.: US 2011/0022769 A1
(43) Pub. Date: Jan. 27, 2011

(54) Translation USB Intermediate Device and Data Rate Apportionment USB Intermediate Device

(75) Inventors: Patrick Siu-Ying Hung, Saratoga, CA (US); Toshimi Sakurai, Shizuoka (JP)

Correspondence Address: HAYNES BEFFEL & WOLFELD LLP, P O BOX 366, HALF MOON BAY, CA, 94019, US

(73) Assignee: CPO Technologies Corporation, Sunnyvale, CA (US)

(21) Appl. No.: 12/684,392

(22) Filed: Jan. 8, 2010

Related U.S. Application Data
(60) Provisional application No. 61/228,581, filed on Jul. 26, 2009.

(51) Int. Cl. G06F 13/20

(52) U.S. Cl. 710/313

(57) ABSTRACT

One aspect of the technology is an apparatus with a USB intermediate device such as a USB hub or a USB composite device. The USB intermediate device includes control circuitry that performs translation between USB 2 communications of the multiple downstream USB 2 ports and USB 3 SuperSpeed communications of the upstream USB 3 port. Another USB intermediate device includes control circuitry that modifies apportionment of the USB 3 maximum data rate among the multiple downstream USB 2 ports, such that the multiple downstream USB 2 ports communicate at a collective data rate exceeding a USB 2 maximum data rate of USB High Speed. Another USB intermediate device includes control circuitry that performs translation and modifies apportionment. Other aspects are a system with a host computer, methods, and computer readable media.

### REFERENCE TO RELATED APPLICATION

The application claims the benefit of U.S. Provisional Application 61/228,581 filed 26 Jul. 2009, which are incorporated by reference herein.

### BACKGROUND

1. Field of the Invention

This technology relates to a USB intermediate device, such as a USB hub device or USB compound device.

2. Description of Related Art

According to the Universal Serial Bus 3.0 Specification, a USB 3.0 hub requires the implementation of a separate USB 2 hub and a separate USB SuperSpeed hub. In this specification-compliant USB 3 hub architecture, all the USB 2 devices that are downstream of the USB 3 hub share the same 480 Mbps bandwidth provided by the USB 2 hub within the specification-compliant USB 3 hub. For example, if five downstream USB 2 devices are connected to the specification-compliant USB 3 hub, then the five USB 2 devices each might have, on average, up to 96 Mbps bandwidth (480 Mbps bandwidth/5 devices).

### SUMMARY

In various embodiments, the upstream port of a USB intermediate device shares the 5 Gbps bandwidth of the upstream port among multiple downstream USB 2 ports of the USB intermediate device. The collective data rate of these multiple downstream USB 2 ports exceeds a 480 Mbps data rate. For example, if five downstream USB 2 devices are connected to the USB intermediate device, then the five USB 2 devices each might have, on average, a 480 Mbps bandwidth. The collective data rate of these five downstream USB 2 devices is 2.4 Gbps, which is less than the 5 Gbps bandwidth of the upstream port. The 2.4 Gbps collective data rate of these five downstream USB 2 devices exceeds the 480 Mbps bandwidth provided by the USB 2 hub within the specification-compliant USB 3 hub.

One aspect of the technology is an apparatus with a USB intermediate device. Examples of the USB intermediate device are a USB hub and a USB composite device. The USB intermediate device includes an upstream USB 3 port, multiple downstream USB 2 ports, and control circuitry.

Downstream is the direction of data flow from the host or away from the host. A downstream port is the port on the USB intermediate device electrically farthest from the host that generates downstream data traffic from the USB intermediate device. Downstream ports receive upstream data traffic.

Upstream is the direction of data flow towards the host. An upstream port is the port on the USB intermediate device electrically closest to the host that generates upstream data traffic from the USB intermediate device. Upstream ports receive downstream data traffic.

The upstream USB 3 port is adapted to electrically connect with a USB 3 host controller of a host computer. The upstream USB 3 port has a USB 3 maximum data rate. The typical USB 3 maximum data rate is the 5 Gbps SuperSpeed bandwidth.

The multiple downstream USB 2 ports are adapted to electrically connect with multiple USB 2 peripherals.

The control circuitry (i) performs translation between USB 2 communications of the multiple downstream USB 2 ports and USB 3 SuperSpeed communications of the upstream USB 3 port; and (ii) modifies apportionment of the USB 3 maximum data rate among the multiple downstream USB 2 ports, such that the multiple downstream USB 2 ports communicate at a collective data rate exceeding a USB 2 maximum data rate of USB High Speed (typically 480 Mbps).

In some embodiments the apparatus violates a USB specification, in that in the apparatus the multiple downstream USB 2 ports communicate at the collective data rate exceeding the USB 2 maximum data rate of USB High Speed, despite the USB specification requiring that a USB specification-compliant USB 3 device has the multiple downstream USB 2 ports communicate at the collective data rate no faster than the USB 2 maximum data rate of USB High Speed.

In some embodiments the apparatus violates a USB specification, in that in the apparatus the USB 2 peripherals appear as USB 3 SuperSpeed peripherals to the USB 3 host controller, despite the USB specification requiring that USB 2 peripherals appear as USB 2 peripherals to the USB 3 host controller.

In one embodiment, the USB 2 communications are half duplex, and USB 3 SuperSpeed communications are full duplex, such that the control circuitry performs translation between half duplex USB 2 communications and dual simplex USB 3 SuperSpeed communications.

Various embodiments are directed to the translation performed by the control circuitry.

In one embodiment the translation is transparent to the USB 3 host controller of the host computer, such that the USB 2 peripherals appear as USB 3 SuperSpeed peripherals to the USB 3 host controller and communications via the upstream USB 3 port with the multiple USB 2 peripherals are compliant with USB 3 SuperSpeed protocol.

In one embodiment the translation is transparent to the USB 3 host controller of the host computer, such that the USB 3 host controller follows a USB SuperSpeed protocol to communicate with the plurality of USB 2 peripherals.

In one embodiment the translation is transparent to the USB 3 host controller of the host computer, such that the USB 3 host controller is unaware of whether the plurality of USB 2 peripherals communicate at USB High Speed, USB Full Speed, or USB Low Speed.

In one embodiment the control circuitry that performs translation, creates a USB 3 SuperSpeed descriptor to represent a USB 2 peripheral connected to one of the plurality of downstream USB 2 ports.

In one embodiment, the control circuitry that performs translation, creates a virtual USB 3 SuperSpeed device to represent a USB 2 peripheral connected to one of the plurality of downstream USB 2 ports.

In one embodiment, the control circuitry that performs translation, creates a virtual USB 3 SuperSpeed device to represent a USB 2 peripheral connected to one of the multiple downstream USB 2 ports. The apparatus further includes a buffer that stores data transferred between the virtual USB 3 SuperSpeed device and the USB 2 peripheral. The buffer can be used to handle flow control.

In one embodiment, the control circuitry that performs translation, creates a virtual USB 3 SuperSpeed device to represent a USB 2 peripheral connected to one of the multiple downstream USB 2 ports, and the control circuitry handles flow control in the upstream SuperSpeed link and between the virtual USB 3 SuperSpeed device and the USB 2 peripheral.

In one embodiment, the control circuitry that performs translation, creates a virtual USB 3 SuperSpeed device to represent a USB 2 peripheral connected to one of the plurality of downstream USB 2 ports, and the control circuitry adds a frame or a micro-frame to isochronous communications between the virtual USB 3 SuperSpeed device and the USB 2 peripheral.

In one embodiment, the control circuitry that performs translation, creates a virtual USB 3 SuperSpeed device to represent a USB 2 peripheral connected to one of the multiple downstream USB 2 ports, and the control circuitry modifies polling of the USB 2 peripheral, to permit the host computer to go to a sleep mode. For example, the control circuitry automatically takes care of the polling of the USB 2 peripheral without intervention from the host computer software/hardware. This allows the host computer to save power.

Another aspect of the technology is a method with the following steps:
in a USB intermediate device, performing translation between USB 2 communications of a plurality of downstream USB 2 ports of the USB intermediate device and USB 3 SuperSpeed communications of an upstream USB 3 port of the USB intermediate device;
in the USB intermediate device, modifying apportionment of a USB 3 maximum data rate of the upstream USB 3 port among the plurality of downstream USB 2 ports, such that the plurality of downstream USB 2 ports communicate at a collective data rate exceeding a USB 2 maximum data rate of USB High Speed.

Another aspect of the technology is the USB intermediate device as described herein, and further including the host computer including the USB 3 host controller.

In one embodiment, the host computer includes code that makes the USB 3 SuperSpeed peripherals appear as USB 2 peripherals.

Another aspect of the technology is a non-transitory computer readable medium with instructions executable by a USB intermediate device including an upstream USB 3 port and multiple downstream USB 2 ports, the upstream USB 3 port adapted to electrically connect with a USB 3 host controller of a host computer and the multiple downstream USB 2 ports adapted to electrically connect with multiple USB 2 peripherals. The instructions include:
translation instructions between USB 2 communications of the multiple downstream USB 2 ports and USB 3 SuperSpeed communications of the upstream USB 3 port; and
apportionment modification instructions of a USB 3 maximum data rate of the upstream USB 3 port among the multiple downstream USB 2 ports, such that the plurality of downstream USB 2 ports communicate at a collective data rate exceeding a USB 2 maximum data rate of USB High Speed.

Another aspect of the technology is an apparatus with a USB intermediate device. The USB intermediate device includes an upstream USB 3 port adapted to electrically connect with a USB 3 host controller of a host computer, the upstream USB 3 port having a USB 3 maximum data rate; multiple downstream USB 2 ports adapted to electrically connect with multiple USB 2 peripherals; and control circuitry that performs translation between USB 2 communications of the multiple downstream USB 2 ports and USB 3 SuperSpeed communications of the upstream USB 3 port. Other aspects are corresponding methods, computer readable media storing the translation instructions, and a system also including the host computer.

Another aspect of the technology is an apparatus with a USB intermediate device. The USB intermediate device includes an upstream USB 3 port adapted to electrically connect with a USB 3 host controller of a host computer, the upstream USB 3 port having a USB 3 maximum data rate; multiple downstream USB 2 ports adapted to electrically connect with multiple USB 2 peripherals; and control circuitry that modifies apportionment of the USB 3 maximum data rate among the multiple downstream USB 2 ports, such that the multiple downstream USB 2 ports communicate at a collective data rate exceeding a USB 2 maximum data rate of USB High Speed. Other aspects are corresponding methods, computer readable media storing the translation instructions, and a system also including the host computer.

### BRIEF DESCRIPTION OF THE DRAWINGS

FIG. 1 is a block diagram of a system including a USB intermediate device between a USB host system and USB devices.

FIG. 2 is a block diagram of a system including a USB intermediate device between a USB host system and USB devices, where the USB intermediate device includes a virtual hub.

FIG. 3 is a block diagram of a system including a USB intermediate device between a USB host system and USB devices, where the USB intermediate device excludes a virtual hub.

FIG. 4 is a bounce diagram among a USB host system, a USB intermediate device, and a USB device, showing an example of a USB control request without data.

FIG. 5 is a bounce diagram among a USB host system, a USB intermediate device, and a USB device, showing an example of a USB control request with data from the USB device to the USB host.

FIG. 6 is a bounce diagram among a USB host system, a USB intermediate device, and a USB device, showing an example of a USB control request with data from the USB host to the USB device.

FIG. 7 is a bounce diagram among a USB host system, a USB intermediate device, and a USB device, showing an example of a USB 3 to USB 2 transfer-level translation (Control Request).

FIG. 8 is a bounce diagram among a USB host system, a USB intermediate device, and a USB device, showing an example of a USB 3 to USB 2 transaction-level translation (Interrupt IN Request).

FIG. 9 is a bounce diagram among a USB host system, a USB intermediate device, and a USB device, showing an example of a typical bulk IN transfer example.

FIG. 10 is a bounce diagram among a USB host system, a USB intermediate device, and a USB device, showing an example of a typical bulk OUT transfer example.

FIG. 11 is a bounce diagram among a USB host system, a USB intermediate device, and a USB device, showing an example of a typical interrupt IN transaction with NAK example.

FIG. 12 is a bounce diagram among a USB host system, a USB intermediate device, and a USB device, showing an example of a typical interrupt IN transaction with ACK example.

FIG. 13 is a bounce diagram among a USB host system, a USB intermediate device, and a USB device, showing an example of a typical interrupt OUT transaction with NAK example.

FIG. 14 is a bounce diagram among a USB host system, a USB intermediate device, and a USB device, showing an example of a typical interrupt OUT transaction with ACK example.

FIG. 15 is a bounce diagram among a USB host system, a USB intermediate device, and a USB device, showing an example of a typical isochronous IN transaction example.

FIG. 16 is a bounce diagram among a USB host system, a USB intermediate device, and a USB device, showing an example of a typical isochronous OUT transaction example.

FIG. 17 is an example diagram of OUT transfers showing multiple outstanding transactions.

FIG. 18 is a block diagram of an example computer host that works with a USB intermediate device and an example computer readable medium with USB intermediate device code.

### DETAILED DESCRIPTION

The present technology has enhancements to the USB (Universal Serial Bus) standards. Incorporated by reference herein are the USB 2 and 3 Specifications, including Universal Serial Bus 3.0 Specification, Revision 1.0, Nov. 12, 2008, and Universal Serial Bus Specification, Revision 2.0, Apr. 27, 2000, available at http://www.usb.org.

As described by the USB specifications, the various USB bus speeds are: SuperSpeed at 5 Gbps, High Speed at 480 Mbps, Full Speed at 12 Mbps, and Low Speed at 1.5 Mbps.

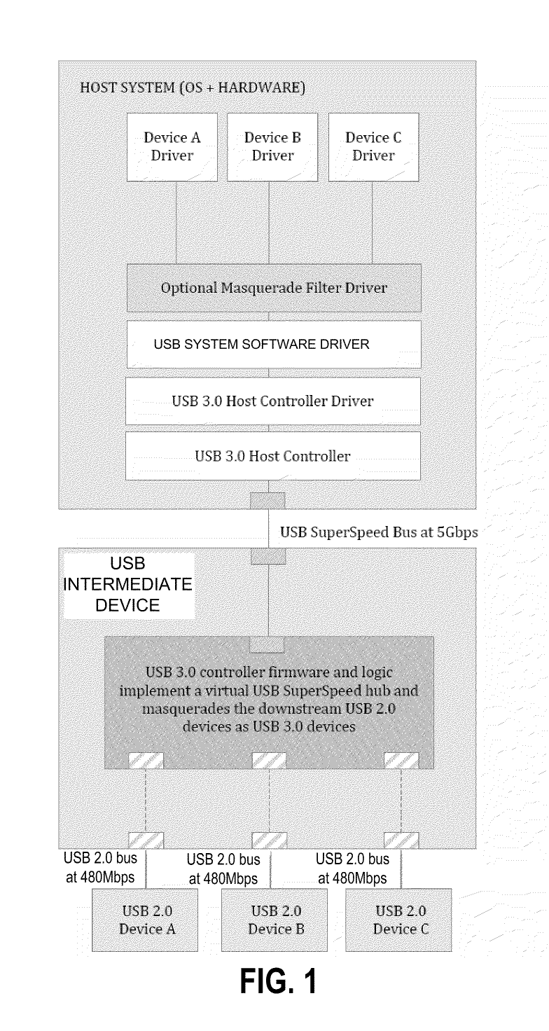

FIG. 1 is a block diagram of a system including a USB intermediate device between a USB host system and USB devices.

The USB intermediate device can use various types of processor model (e.g. ARM7 or ARM9 processor), bus architecture (e.g. AMBA 2 or AMBA 3 bus), clock speeds, memory sizes (e.g. ROM and RAM sizes), DMA controller type (e.g. register based or scatter/gather), and software interface (e.g. hardware register and Interrupt definition).

On the System Host side, there are four hardware and software layers:
The Client Software manages an interface of USB function using a pipe bundle consisting of a number of stream pipes and message pipes.
The USB System Software manages all USB logical devices using the default control pipe to endpoint zero in each USB logical device.
The Host Controller Software and Host Controller Hardware manage the USB 3 protocol layer, link layer, and physical layer.

These four Host System layers are used in the standard USB communications. In most USB applications, there is no need to modify these layers in the Host System to support the masquerade mode. However, if the USB Client Software checks for the USB connection speed and can only run at USB 2 connection speed, it may be necessary to add a simple filter driver between USB Client Software and USB System Software. The filter driver essentially hard codes the USB connection speed to USB 2. As a result, the USB Client Software can still work with a USB 3 device.

This optional filter driver can be inserted before or after the USB 3 driver in the host operating system. The main purpose of this filter is to de-masquerade the devices in case the client drivers can only work with USB 2 devices.

The USB 2.0 Specification has discussion about the system generally at Chapters 10.3, 10.4, 10.5, and 10.6.

In some operating systems, it is straightforward to masquerade multiple USB 2 mass storage devices as USB 3 mass storage devices, because no additional software driver is needed.

A USB 2 device is “masqueraded” as a USB 3 device to take advantage of the higher bandwidth in SuperSpeed buses.

In a docking station application, it is efficient to use masquerade mode to support multiple fixed USB 2 devices inside the docking station.

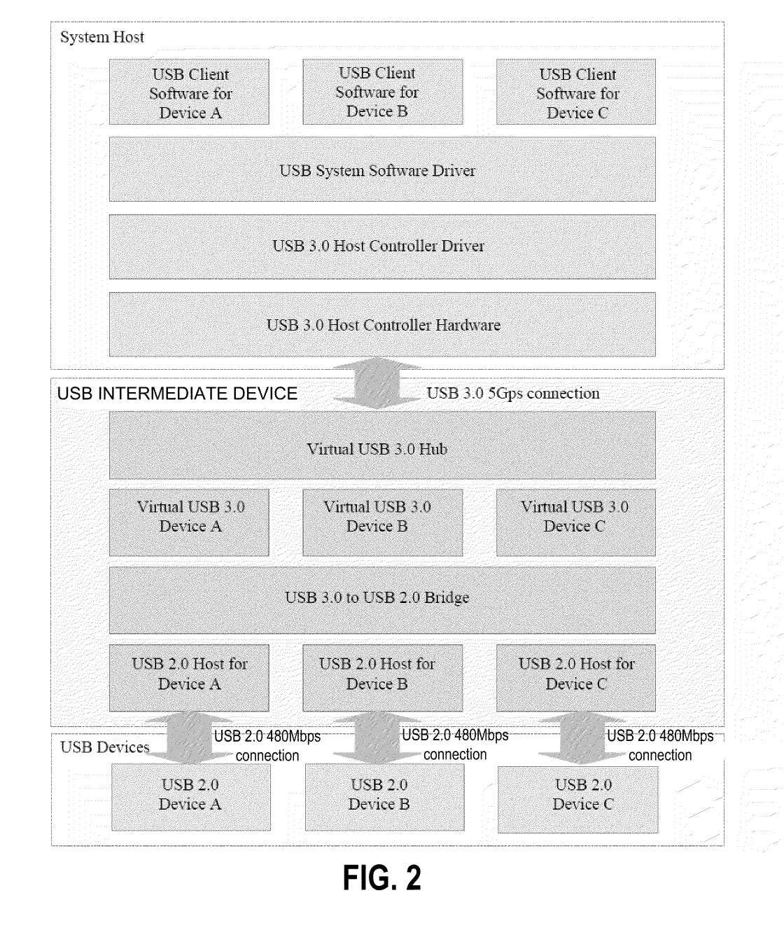

FIG. 2 is a block diagram of a system including a USB intermediate device between a USB host system and USB devices, where the USB intermediate device includes a virtual hub.

The virtual USB 3 hub layer manages the USB 3 connection between the USB intermediate device and the external USB 3 host, and allows the intermediate device to support multiple USB 3/USB 2 downstream devices. The virtual hub allows multiple USB 2 devices to be masqueraded. The virtual USB 3 hub layer is implemented by firmware similarly as a real USB 3 hub.

The virtual USB 3 device layer manages all the USB devices visible to the host USB client software. The virtual USB 3 device layer is implemented by firmware similarly as a real USB 3 device.

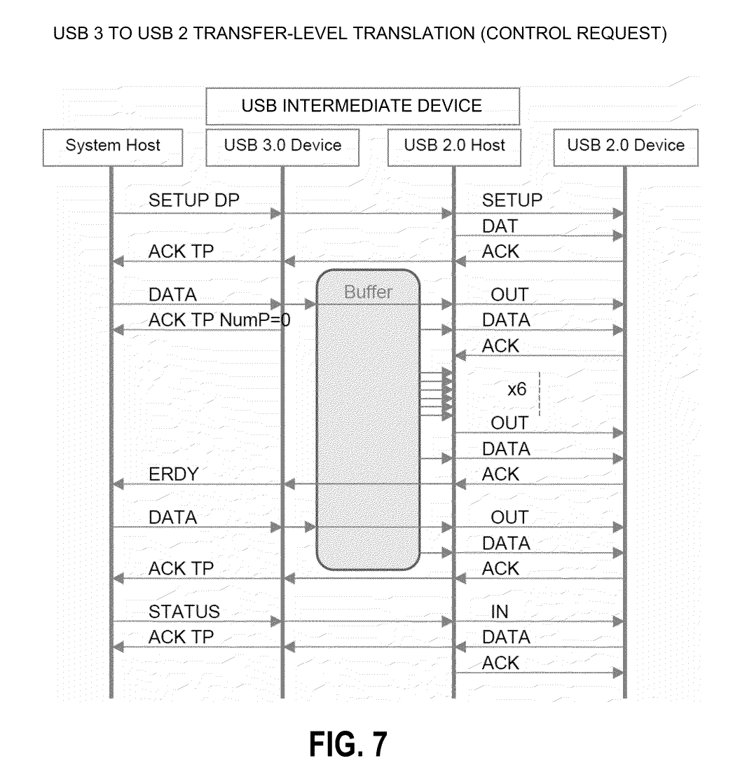

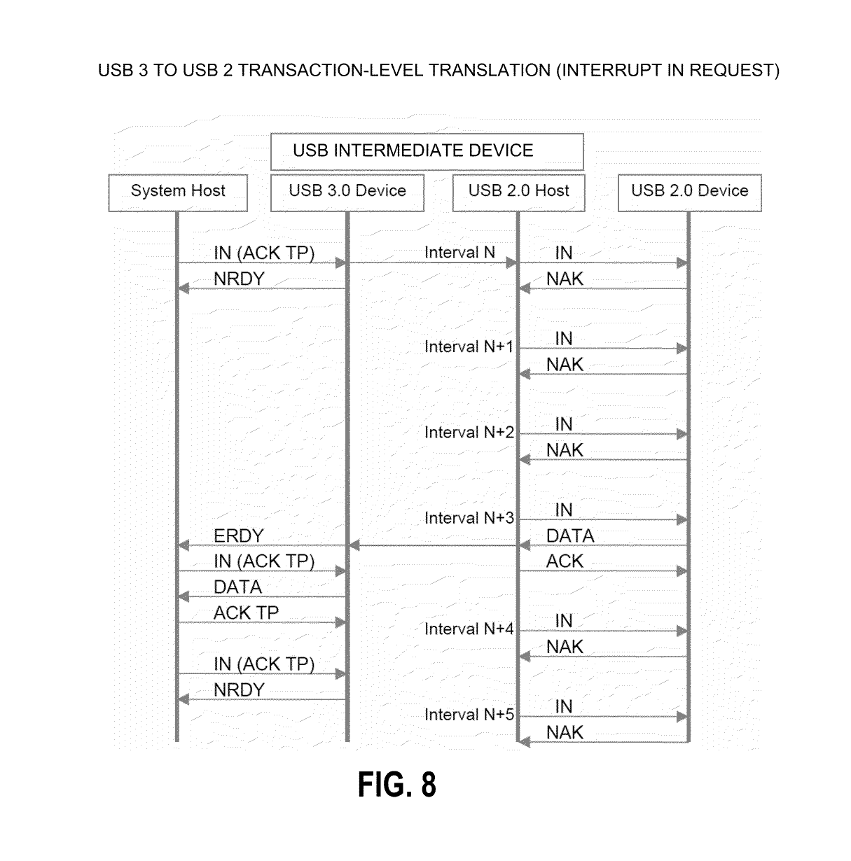

The USB 3 to USB 2 bridge layer manages the USB transfers and transactions between USB 3 protocol/link layers and USB 2 protocol/link layers. All USB 3 transfers are converted to USB 2 transfers using the transfer-level and transaction-level translation schemes described in connection with FIGS. 7 and 8. The virtual USB SuperSpeed to USB 2 bridge includes the following logic blocks:

The USB Event Handler manages the USB events in the virtual USB 3 hub and the USB events in USB 2 hosts. USB Event Handler is described in connection with Tables 2 and 3 below.

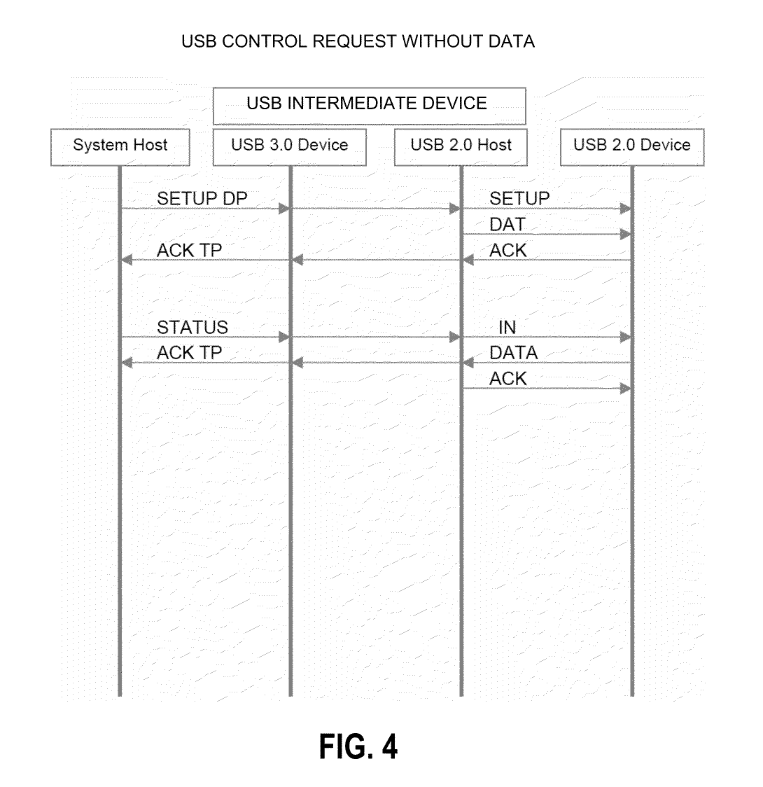

The USB Control Transfer Handler manages the USB Control transfers issued by the System Host. The USB Control Transfer Handler is described in connection with Table 1 below and FIGS. 4-6.

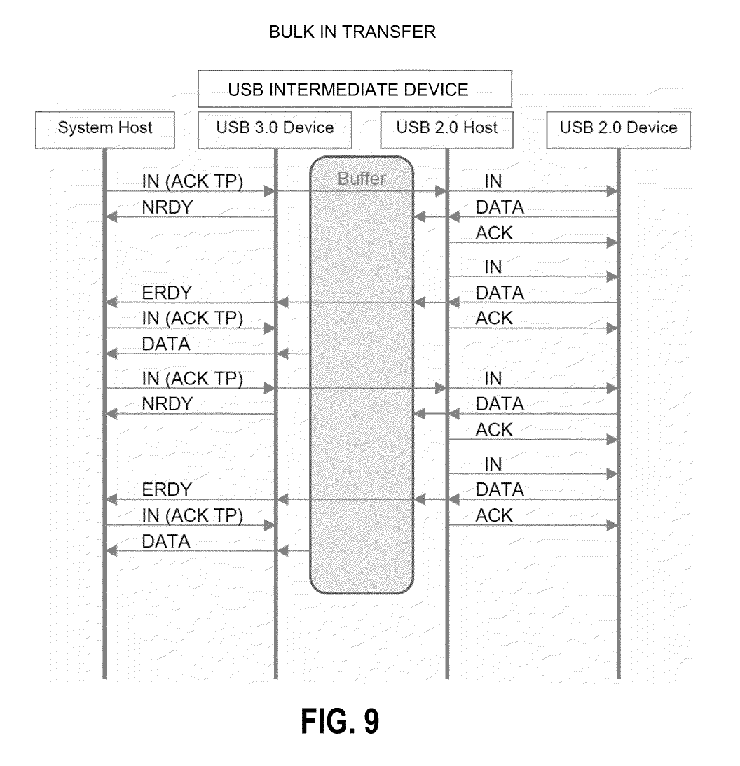

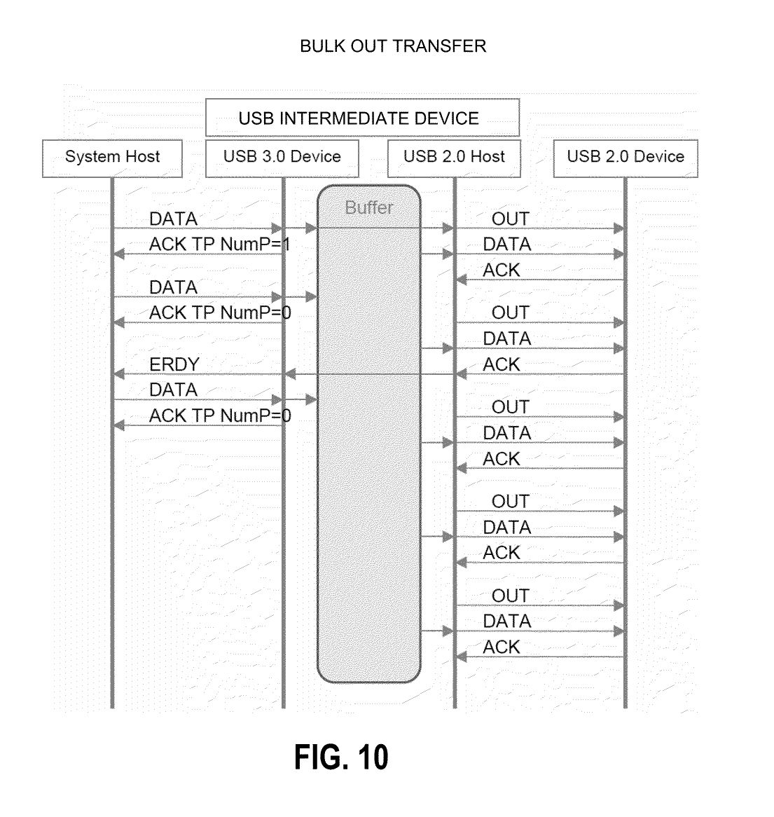

The USB Bulk Transfer Handler manages the USB Bulk transfers issued by the System Host. The USB Bulk Transfer Handler is described in connection with FIGS. 9 and 10.

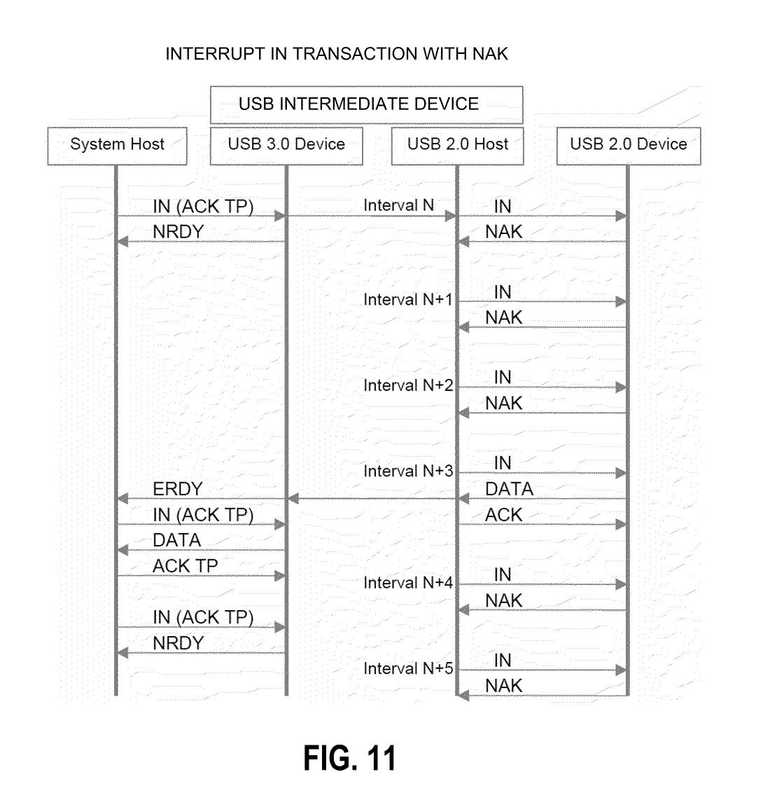

The USB Interrupt Transaction Handler manages the USB Interrupt transfers issued by System Host. The USB Interrupt Transaction Handler is described in connection with FIGS. 11-14.

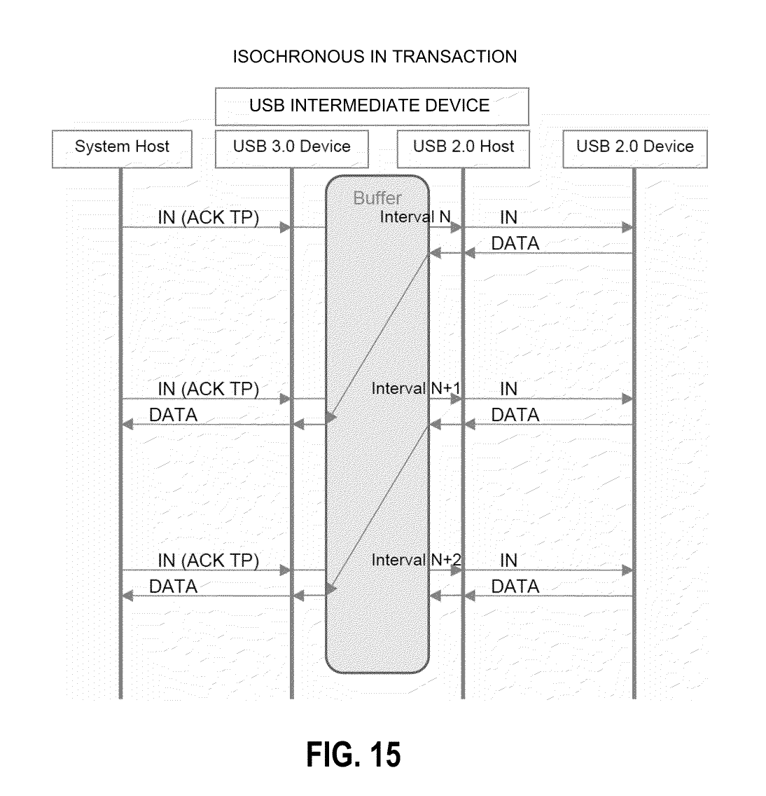

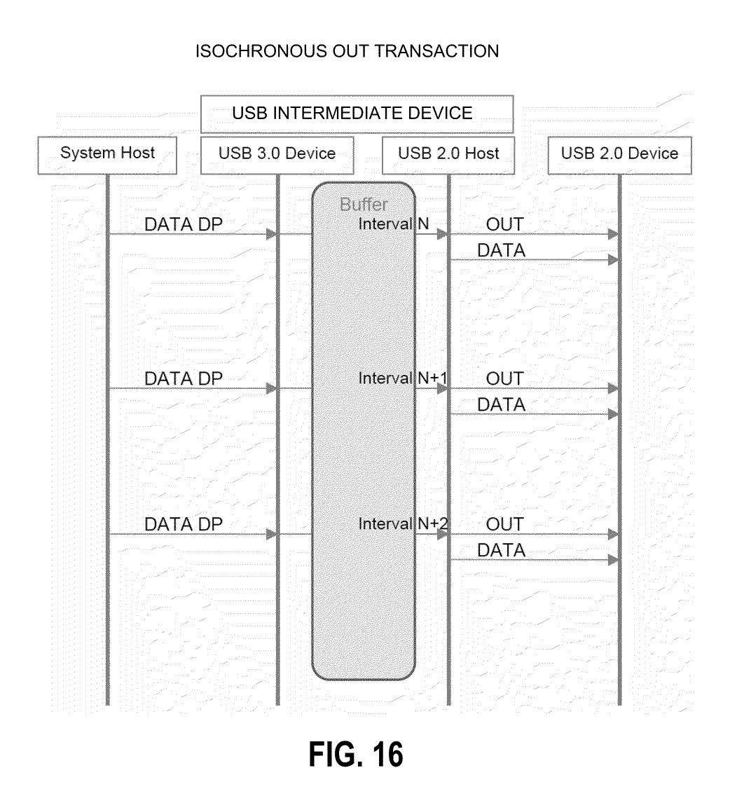

USB Isochronous Transaction Handler manages the USB Isochronous transfers issued by the System Host. The USB Isochronous Transaction Handler is described in connection with FIGS. 15 and 16.

The preceding five logic blocks take care of the masquerade logic and the flow control logic. The masquerade logic is responsible for handling all upstream and downstream USB descriptors and end point configurations. It reports the downstream USB 2 devices as USB 3 devices. The flow control makes sure there is no underflow and overflow condition on both USB SuperSpeed and USB 2 sides. It maintains a local FIFO buffer to handle the incoming and outgoing transactions.

In addition, a USB 2 polling block, incorporated within each downstream USB 2.0 port, checks the status of USB 2 devices even in power saving states.

A direct translation from USB SuperSpeed transactions to USB 2 transactions cannot work reliably because:
USB SuperSpeed supports continuous bursting while USB 2 does not.
USB SuperSpeed supports link-level error detection and recovery and flow control while USB 2 does not.
USB SuperSpeed is a dual-simplex unicast bus while USB 2 is a half-duplex broadcast bus.
USB SuperSpeed uses asynchronous notifications while USB 2 uses a polling model.

The USB 2 host layer manages the USB 2 connection between the USB intermediate device and the external USB 2 devices. The USB 2 host layer is implemented by firmware similarly as a real USB 2 host.

Accordingly, the firmware manages resources and state variables in all real and virtual USB hosts, devices, and hubs. For example in FIG. 2, the firmware and hardware are required to manage the resources and state variables in one virtual USB 3 hub (with one real USB 3 device), three virtual USB 3 devices, and three real USB 2 hosts. At a minimum, the firmware and hardware keeps track of the following state variables for each USB host and device:
Device State: Default, Address, or Configured
USB Address
Configuration Number
Interface Number
Standard Descriptors
Endpoint Halt Status

Additionally, the firmware and hardware manage the data buffer used in transfer-level translation and transaction-level translation described in connection with FIGS. 7 and 8. DMA is used to move data during transfer-level translation and transaction-level translation.

The virtual USB 3.0 hub corresponds to a real USB 3.0 hub and is described in the USB 3.0 Specification at Chapter 10 and the USB 2.0 Specification at Chapter 11.

The virtual USB 3.0 device corresponds to a real USB 3.0 device and is described in the USB 3.0 Specification at Chapter 9 and the USB 2.0 Specification at Chapter 9.

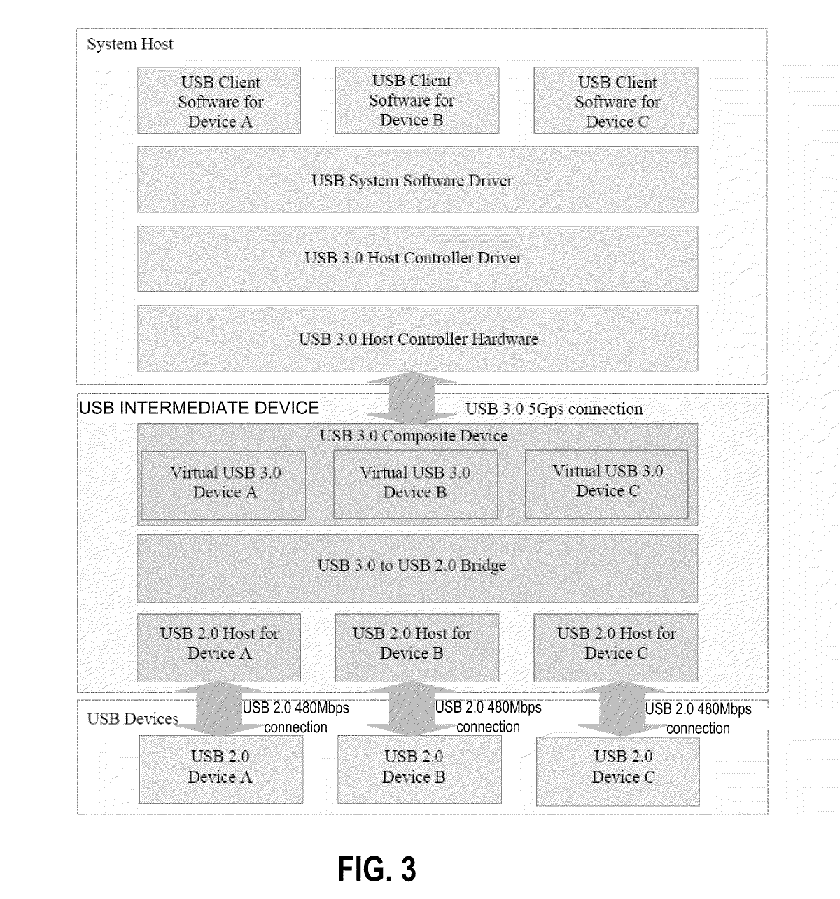

The USB 2.0 host layer is described in the USB 2.0 Specification at Chapter 10.2 and Chapter 11.5. FIG. 3 is a block diagram of a system including a USB intermediate device between a USB host system and USB devices, where the USB intermediate device excludes a virtual hub.

From the System Host's perspectives, FIG. 2 shows a USB 3 compound device with a USB 3 hub connecting to a number of USB 3 devices. This compound device implementation is suitable for most USB applications. However in some applications (e.g. USB docking station), the USB 2 devices are permanently connected to the USB intermediate device, and a simpler USB 3 composite device may suffice. FIG. 3 shows a composite device implementation with three USB 3 devices. Compared to FIG. 2, the virtual USB 3 hub is missing in the composite device implementation. Generally speaking, the composite device implementation is similar to the compound device implementation described earlier, except that the composite device implementation cannot handle dynamic connection and disconnection and does not contain a USB 3 virtual hub. As a result, the composite device implementation can consume significantly less firmware resources, but is also less flexible.

Enumeration, Initialization, and Configuration

The following discusses the USB Control Transfer Handler.

Each USB device is required to implement the default control pipe, which provides access to the USB device's configuration, status and control information. Using Control transfers to the default control pipe, the client software can issue requests to access the USB device's configuration, status and control information.

Generally speaking, Control transfers can be issued to the default control pipe as well as non-default control pipes. For non-default control pipes, the corresponding USB 2 host can simply issue the same Control transfers to the USB 2 device using the transfer-level translation scheme described in connection with FIGS. 7 and 8. For the default control pipes, the Control transfers have to be processed differently, depending on the request type. Since the default control pipe requests are typically only sent during bus enumeration stage and do not affect device performance during normal operation, the Control transfer handler can be implemented in firmware allowing more flexibility and configurability.

The following table describes how to process the default control pipe control requests received by the virtual USB 3 device. For instance, if the virtual USB 3 device receives a SET_FEATURE (ENDPOINT_HALT) request, the corresponding USB 2 host should issue the same request using the transfer-level translation scheme described in connection with FIGS. 7 and 8. In addition, the firmware should also update the ENDPOINT_HALT status in the corresponding endpoint data structure.

TABLE 1: USB 2 host reaction responding to client software requests to corresponding USB 3 device.

| DATA | USB 3 DEVICE | USB 2 HOST |
|---|---|---|
| DIRECTION | REQUEST | REACTION |
| NO DATA | SET_FEATURE | Issue the same USB command |
| | (ENDPOINT_HALT) | using transfer-level translation |
| | | scheme. Update firmware |
| | | endpoint data structure. |
| NO DATA | SET_FEATURE | Update firmware endpoint |
| | (U1/U2_ENABLE) | data structure. |
| NO DATA | SET_FEATURE | Update firmware endpoint |
| | (LTM_ENABLE) | data structure. |
| NO DATA | CLEAR_FEATURE | Issue the same USB command |
| | (ENDPOINT_HALT) | using transfer-level translation |
| | | scheme. Update firmware |
| | | endpoint data structure. |
| NO DATA | CLEAR_FEATURE | Update firmware endpoint |
| | (U1_ENABLE, | data structure. |
| | U2_ENABLE) | |
| NO DATA | CLEAR_FEATURE | Update firmware endpoint |
| | (LTM_ENABLE) | data structure. |
| NO DATA | SET_ADDRESS | Issue the same USB command |
| | | using transfer-level translation |
| | | scheme. Update firmware |
| | | endpoint data structure. |
| NO DATA | SET_CONFIGURATION/ | Issue the same USB command |
| | SET_INTERFACE | using transfer-level translation |
| | | scheme. Update firmware |
| | | endpoint data structure. |
| NO DATA | SET_ISOCH_DELAY | No action. |
| DEVICE | GET_CONFIGURATION | Issue the same USB command |
| TO HOST | | using transfer-level translation |
| | | scheme. |
| DEVICE | GET_INTERFACE | Issue the same USB command |
| TO HOST | | using transfer-level translation |
| | | scheme. |
| DEVICE | GET_DESCRIPTIOR | Issue the same USB command |
| TO HOST | (DEVICE) | using transfer-level translation |
| | | scheme but the following fields |
| | | in the return data may be |
| | | modified based on system |
| | | configuration: |
| | | bcdUSB |
| | | bMaxPacketSize |
| DEVICE | GET_DESCRIPTOR | Issue the same USB command |
| TO HOST | (CONFIGURATION) | using transfer-level translation |
| | | scheme but the following fields |
| | | in the return data may be |
| | | modified based on system |
| | | configurations: |
| | | bMaxPower |
| | | wMaxPacketSize |
| | | bInterval |
| | | Interface Association |
| DEVICE | GET_DESCRIPTOR | Issue the same USB command |
| TO HOST | (STRING) | using transfer-level translation |
| | | scheme. |
| DEVICE | GET)_DESCRIPTOR | No action. |
| TO HOST | (BOS) | |
| DEVICE | GET_STATUS | Issue the same USB command |
| TO HOST | (DEVICE) | using transfer-level translation |
| | | scheme but the following fields |
| | | in the return data may be |
| | | modified based on system |
| | | configurations: |
| | | U1_ENABLE |
| | | U2_ENABLE |
| | | LTM_ENABLE |
| DEVICE | GET_STATUS | Issue the same USB command |
| TO HOST | (INTERFACE) | using transfer-level translation |
| | | scheme. |
| DEVICE | GET_STATUS | Issue the same USB command |
| TO HOST | (ENDPOINT) | using transfer-level translation |
| | | scheme. |
| DEVICE | SYNC_FRAME | Issue the same USB command |
| TO HOST | | using transfer-level translation |
| | | scheme. |
| HOST | SET_SEL | No action. |
| TO DEVICE | | |
| ANY | OTHER REQUESTS | Issue the same USB command |
| | | using transfer-level translation |
| | | scheme. |

FIG. 4 is a bounce diagram among a USB host system, a USB intermediate device, and a USB device, showing an example of a USB control request without data.

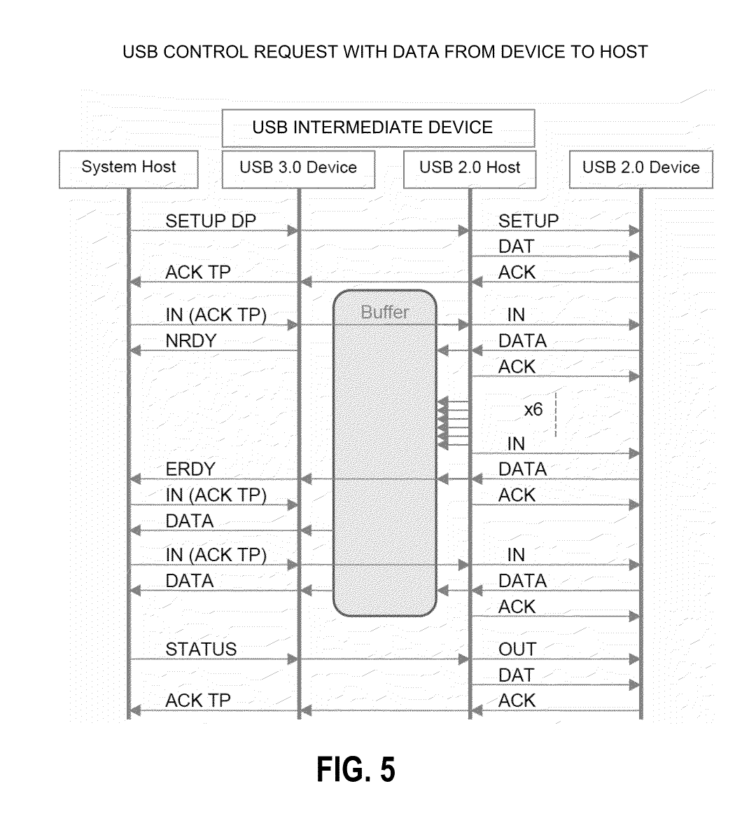

FIG. 5 is a bounce diagram among a USB host system, a USB intermediate device, and a USB device, showing an example of a USB control request with data from the USB device to the USB host.

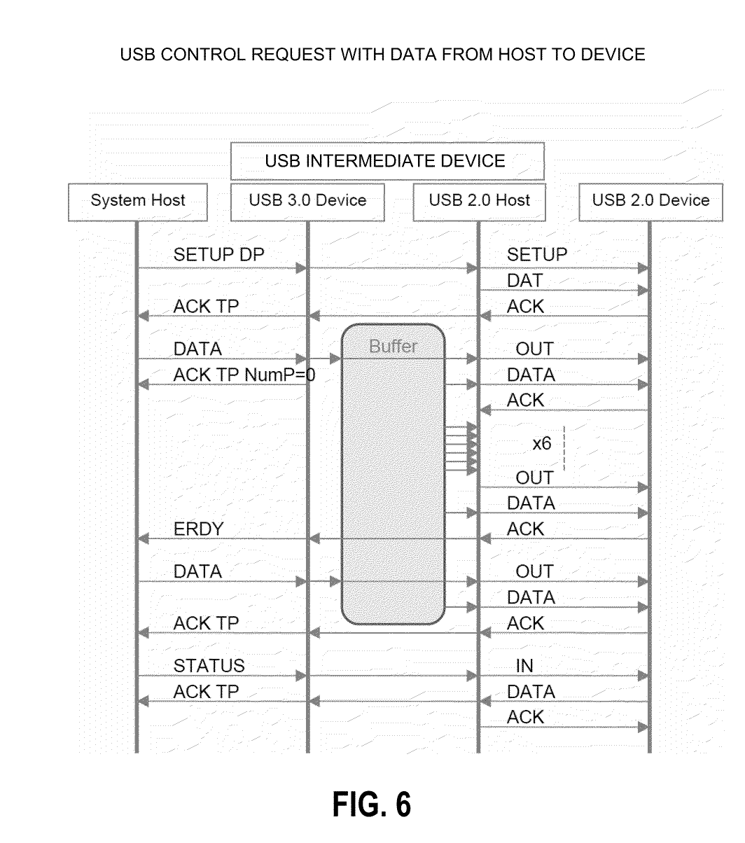

FIG. 6 is a bounce diagram among a USB host system, a USB intermediate device, and a USB device, showing an example of a USB control request with data from the USB host to the USB device.

Data Translation

The following discussion is about transfer-level and transaction-level translation. In USB terminology, a USB transfer consists of one or more bus transactions moving information between a software client and its USB function. There are four standard USB transfer types: Control, Bulk, Interrupt and Isochronous transfers.

For Control and Bulk transfers, the USB 3 to USB 2 Bridge handles one transfer at a time, meaning that the bridge state machine may have to manage multiple transactions. For Interrupt and Isochronous transfers, the USB 3 to USB 2 Bridge handles one transaction at a time, meaning that the bridge state machine only needs to manage one transaction.

The conversion from USB 3 transfers to USB 2 transfers is called transfer-level translation and the conversion from USB 3 transactions to USB 2 transactions is called transaction-level translation. The transfer-level translation scheme is used for Control and Bulk transfers, and the transaction-level translation scheme is used for Interrupt and Isochronous transfers.

Although USB 3 is architected to re-use USB 2 protocol and software model, there are key differences which make it challenging to convert USB 3 transfers to USB 2 transfers. One key difference between the two standards is in the area of flow control. USB 3 uses a more sophisticated and efficient flow control scheme in order to achieve higher bandwidth. In addition, the USB 3 protocol level transaction packets (ACK, NRDY, ERDY) also provide more efficient handshaking between host and device. The USB 3 link level flow control is described in Section 7 of the USB 3 specification. The USB 3 protocol level transaction packets are described in Section 8 of the USB 3 specification. In many embodiments, the USB link and protocol layer control is expected to be handled by the third-party USB 2 and USB 3 controllers. However, the data transfer and buffering is handled by the USB intermediate device's DMA controller with firmware assistance and control.

FIG. 7 is a bounce diagram among a USB host system, a USB intermediate device, and a USB device, showing an example of a USB 3 to USB 2 transfer-level translation (Control Request).

FIG. 8 is a bounce diagram among a USB host system, a USB intermediate device, and a USB device, showing an example of a USB 3 to USB 2 transaction-level translation (Interrupt IN Request).

All USB 3 Bulk transfers are converted to USB 2 Bulk transfers using the transfer-level translation described in connection with FIGS. 7 and 8.

FIG. 9 is a bounce diagram among a USB host system, a USB intermediate device, and a USB device, showing an example of a typical bulk IN transfer example.

FIG. 10 is a bounce diagram among a USB host system, a USB intermediate device, and a USB device, showing an example of a typical bulk OUT transfer example.

All USB 3 Interrupt transactions are converted to USB 2 Interrupt transactions using the transaction-level translation scheme described in connection with FIGS. 7 and 8.

FIG. 11 is a bounce diagram among a USB host system, a USB intermediate device, and a USB device, showing an example of a typical interrupt IN transaction with NAK example.

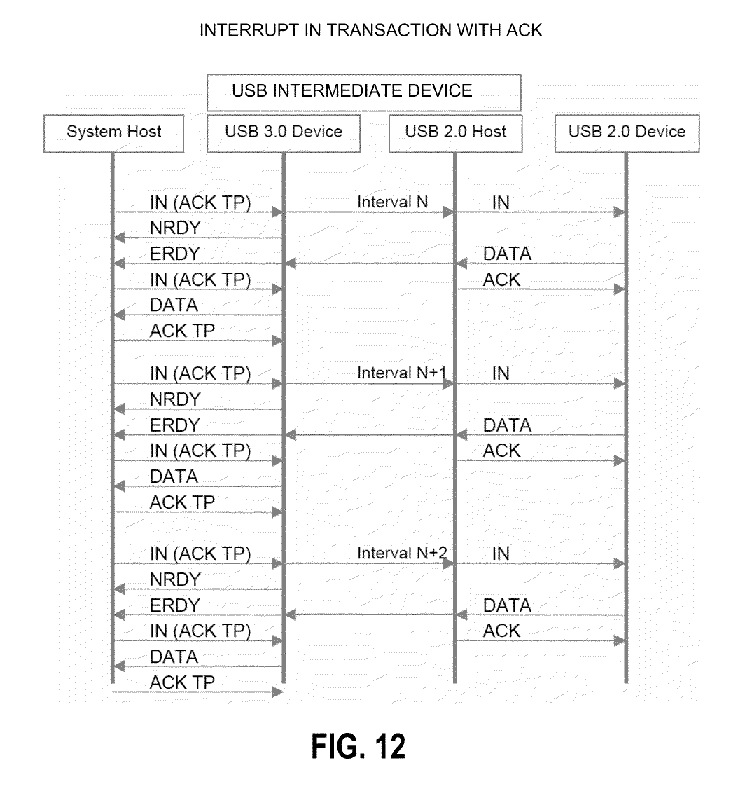

FIG. 12 is a bounce diagram among a USB host system, a USB intermediate device, and a USB device, showing an example of a typical interrupt IN transaction with ACK example.

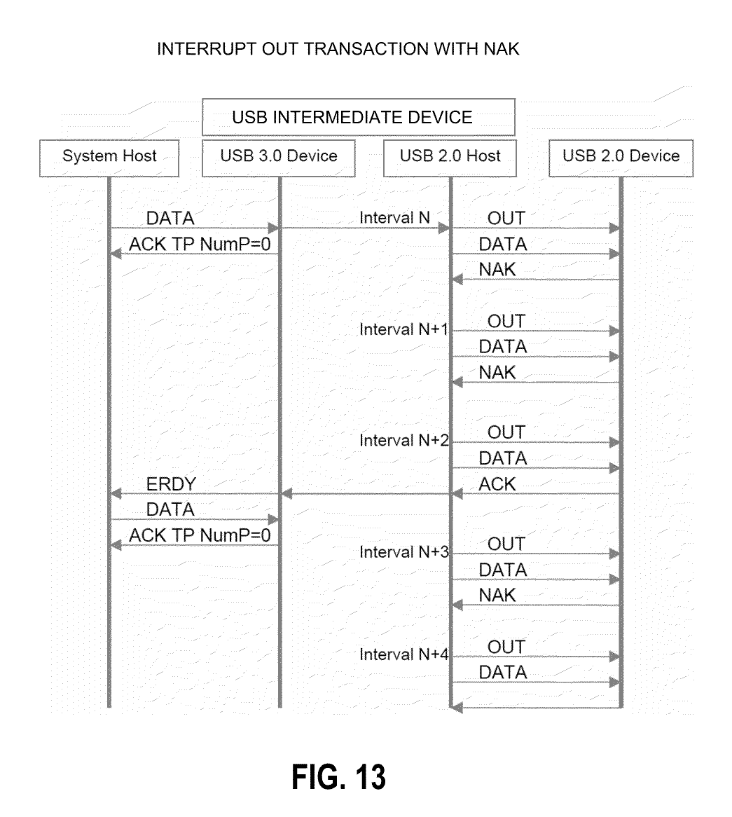

FIG. 13 is a bounce diagram among a USB host system, a USB intermediate device, and a USB device, showing an example of a typical interrupt OUT transaction with NAK example.

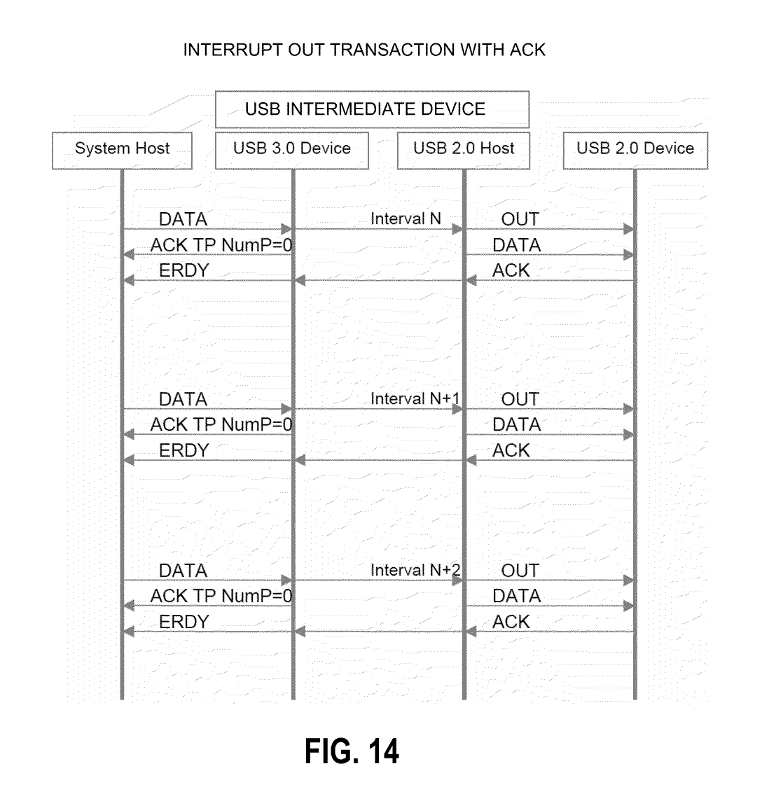

FIG. 14 is a bounce diagram among a USB host system, a USB intermediate device, and a USB device, showing an example of a typical interrupt OUT transaction with ACK example.

All USB 3 Isochronous transactions are converted to USB 2 Isochronous transactions using the transaction-level translation scheme described in connection with FIGS. 7 and 8. Note that there is a 125 us delay for Isochronous IN transactions. This is because USB 2 devices are too slow (480 Mbps) causing USB 3 devices possibly not be able to respond the transaction in time. As a result, the return data is held for an extra micro-frame (125 us).

FIG. 15 is a bounce diagram among a USB host system, a USB intermediate device, and a USB device, showing an example of a typical isochronous IN transaction example.

FIG. 16 is a bounce diagram among a USB host system, a USB intermediate device, and a USB device, showing an example of a typical isochronous OUT transaction example.

USB Event Handling

The USB event handler manages the USB events occurring in the virtual USB 3 hub and the USB events occurring in the USB 2 hosts. Most importantly, the USB event handler manages the virtual connection and disconnection of the virtual USB 3 devices.

The following table shows the corresponding USB 2 host reaction when a USB event occurs in the virtual USB 3 hub

TABLE 2
USB 2 host reaction responding to USB event
in the corresponding USB 3 device.

| USB 3 HUB EVENT | USB 2 HOST REACTION |
|---|---|
| Connect | No action |
| Disconnect | Proceed to Disconnect state |
| Bus reset | Perform USB 2 bus reset |
| U1 | No action |
| U2 | No action |
| U3 | Proceed to Suspend state |
| Resume | Perform Resume signaling |
| Receive ITP | Perform uSOF timer |
| | synchronization |

The following table shows the corresponding virtual USB 3 hub reaction when a USB event occurs in the USB 2 host.

TABLE 3
Virtual USB 3 hub reaction responding to the
corresponding USB 2 event.

| USB 2 HOST EVENT | VIRTUAL USB 3 HUB REACTION |
|---|---|
| Connect | Perform Connect event on |
| | virtual USB 3 hub |
| Disconnect | Perform Disconnect event on |
| | virtual USB 3 hub |
| Over-current | Perform Over-current event on |
| | virtual USB 3 hub |
| U3 | Proceed to Suspend state |
| Remote wake-up | Perform remote wakeup (LFPS) |
| | signaling from USB 3 port |

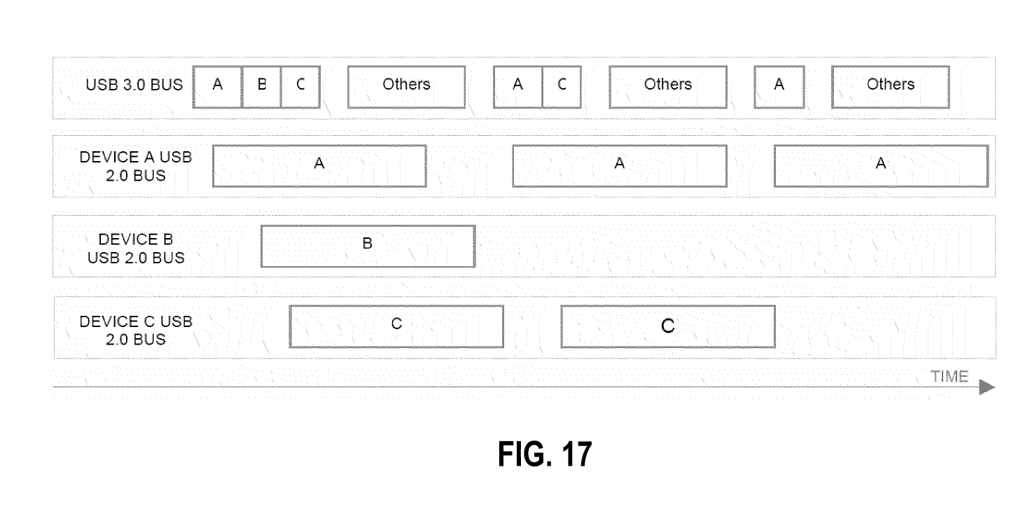

FIG. 17 is an example diagram of OUT transfers showing multiple outstanding transactions.

Based on the size of the internal FIFO, multiple transactions on the USB 3 side can be outstanding and can be temporarily stored in the USB intermediate device.

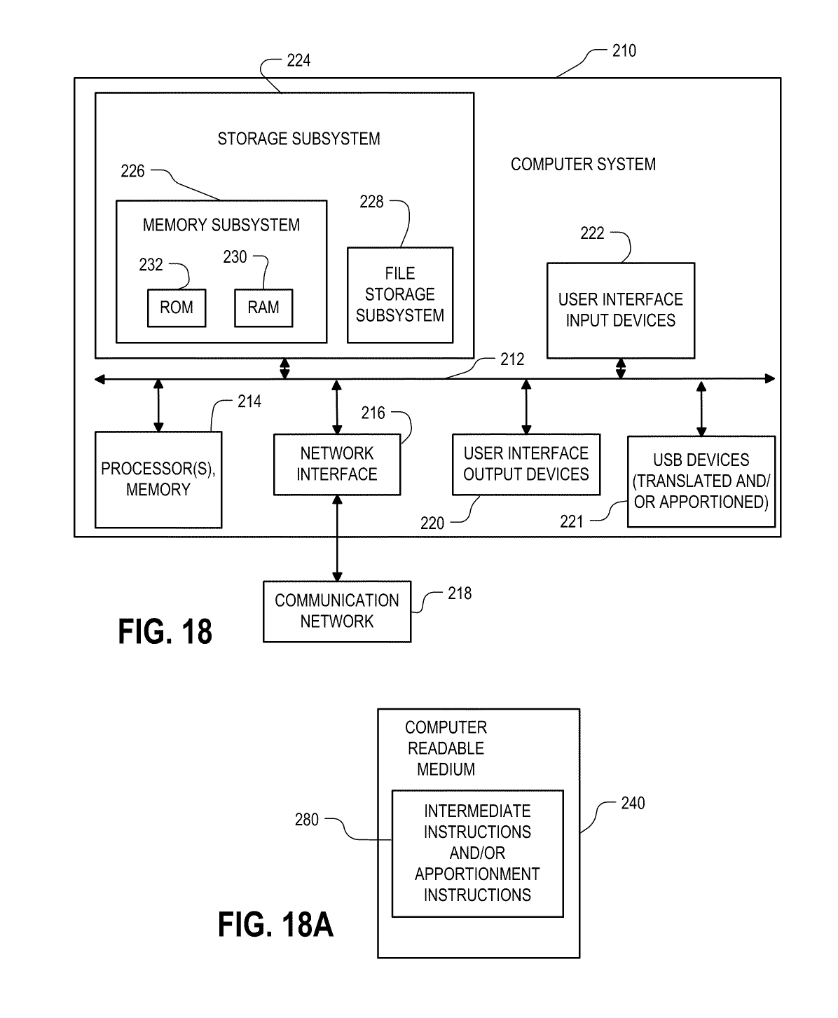

FIG. 18 is a block diagram of an example computer host that works with a USB intermediate device and an example computer readable medium with USB intermediate device code.

Computer system 210 typically includes a processor subsystem 214 which communicates with a number of peripheral devices via bus subsystem 212. These peripheral devices may include a storage subsystem 224, comprising a memory subsystem 226 and a file storage subsystem 228, user interface input devices 222, user interface output devices 220, and a network interface subsystem 216. The input and output devices allow user interaction with computer system 210. Network interface subsystem 216 provides an interface to outside networks, including an interface to communication network 218, and is coupled via communication network 218 to corresponding interface devices in other computer systems. Communication network 218 may comprise many interconnected computer systems and communication links. These communication links may be wireline links, optical links, wireless links, or any other mechanisms for communication of information. While in one embodiment, communication network 218 is the Internet, in other embodiments, communication network 218 may be any suitable computer network.

The physical hardware component of network interfaces are sometimes referred to as network interface cards (NICs), although they need not be in the form of cards: for instance they could be in the form of integrated circuits (ICs) and connectors fitted directly onto a motherboard, or in the form of macrocells fabricated on a single integrated circuit chip with other components of the computer system.

User interface input devices 222 may include a keyboard, pointing devices such as a mouse, trackball, touchpad, or graphics tablet, a scanner, a touch screen incorporated into the display, audio input devices such as voice recognition systems, microphones, and other types of input devices. In general, use of the term “input device” is intended to include all possible types of devices and ways to input information into computer system 210 or onto computer network 218.

User interface output devices 220 may include a display subsystem, a printer, a fax machine, or non visual displays such as audio output devices. The display subsystem may include a cathode ray tube (CRT), a flat panel device such as a liquid crystal display (LCD), a projection device, or some other mechanism for creating a visible image. The display subsystem may also provide non visual display such as via audio output devices. In general, use of the term “output device” is intended to include all possible types of devices and ways to output information from computer system 210 to the user or to another machine or computer system.

USB device subsystem 221 connects to a USB intermediate device as described herein.

Storage subsystem 224 stores the basic programming and data constructs that provide the functionality of certain aspects of the present invention. These software modules are generally executed by processor subsystem 214. The data constructs stored in the storage subsystem 224 also can include any technology files, and other databases. Note that in some embodiments, one or more of these can be stored elsewhere but accessibly to the computer system 210, for example via the communication network 218 or USB devices 221.

Memory subsystem 226 typically includes a number of memories including a main random access memory (RAM) 230 for storage of instructions and data during program execution and a read only memory (ROM) 232 in which fixed instructions are stored. File storage subsystem 228 provides persistent storage for program and data files, and may include a hard disk drive, a floppy disk drive along with associated removable media, a CD ROM drive, an optical drive, or removable media cartridges. The translation and apportionment programs 280 implementing the functionality of certain embodiments of the invention may have been provided on a computer readable medium including transitory media, and nontransitory media 240 such as one or more CD-ROMs (or may have been communicated to the computer system 210 via the communication network 218), and may be stored by file storage subsystem 228. The host memory 226 contains, among other things, computer instructions which, when executed by the processor subsystem 210, cause the computer system to operate or perform functions as described herein. As used herein, processes and software that are said to run in or on “the host” or “the computer”, execute on the processor subsystem 214 in response to computer instructions and data in the host memory subsystem 226 including any other local or remote storage for such instructions and data.

Bus subsystem 212 provides a mechanism for letting the various components and subsystems of computer system 210 communicate with each other as intended. Although bus subsystem 212 is shown schematically as a single bus, alternative embodiments of the bus subsystem may use multiple busses.

Computer system 210 itself can be of varying types including a personal computer, a portable computer, a workstation, a computer terminal, a network computer, a television, a mainframe, or any other data processing system or user device. Due to the ever changing nature of computers and networks, the description of computer system 210 depicted in FIG. 18 is intended only as a specific example for purposes of illustrating the preferred embodiments of the present invention. Many other configurations of computer system 210 are possible having more or less components than the computer system depicted in FIG. 18.

Bandwidth Apportionment

Both the USB intermediate device and the USB host controller can affect the device bandwidths. In many embodiments, the USB intermediate device is not a network device that distributes bandwidth “evenly” among multiple downstream ports. Although the bandwidth distribution task is performed mainly by the USB host controller in the host computer, the USB intermediate device also can affect the bandwidth distribution task.

The USB intermediate device arbitrates the upstream traffic—data traffic from multiple devices to host. Generally, “many to one” requires arbitration. The USB intermediate device may adopt different arbitration policies, such as fixed priority or round robin to control the upstream traffic. For such upstream data flow, the USB intermediate device can prioritize a device over another device, because all these devices are sharing the same upstream port. Thus, the USB intermediate device can affect the apportionment.

The USB intermediate device does not need to arbitrate the downstream traffic—data traffic from the host to multiple devices. Generally, “one to many” does not require arbitration. Unlike the USB intermediate device, the USB host controller controls the downstream traffic. For such downstream data flow, the USB intermediate device performs the appropriate transaction but does not affect the bandwidth distribution.

However, in either the upstream or downstream cases, bandwidth may need to be selectively apportioned, if the aggregate bandwidth requirement of the multiple devices exceeds the bandwidth of the host.

The following discussion provides examples of apportioning the USB 3 maximum data rate among multiple downstream USB ports.

In the first case, available upstream bandwidth exceeds or equals the total downstream bandwidth requirements. For example, 4 downstream USB 2 devices are downstream of 1 USB 3 SuperSpeed port.

In this example, a distribution policy is not very important. The device bandwidths are not seriously affected by the distribution policy because the bandwidths are essentially “optimized”.

In the second case, upstream bandwidth is less than the total downstream bandwidth requirements. For example, 10 USB 3 SuperSpeed devices and 10 downstream USB 2 devices are downstream of 1 USB 3 SuperSpeed port.

In this example, the distribution policy affects available bandwidth of each device.

One distribution policy is a fixed policy, such as prioritizing USB 2 devices over USB 3 SuperSpeed devices. In such a policy, the USB 3 SuperSpeed devices share bandwidth which is left over after meeting the bandwidth requirements of the USB 2 devices.

Another distribution policy is a round robin policy, in which the devices taken turns.

Yet another distribution policy is a combination of a fixed policy and a round robin policy. For example, the USB 2 devices are prioritized over USB 3 SuperSpeed devices, and the USB 3 SuperSpeed devices take turns in priority.

Such distribution policies can be enforced by an arbiter inside the USB intermediate device. The arbiter arbitrates among multiple bandwidth requests that arrive. When multiple downstream transactions arrive at same time, one at a time goes through the upstream port. Such distribution policies can be enforced by the host controller as well, to prefer one stream over another.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. An apparatus, comprising:
a USB intermediate device, including:
an upstream USB 3 port adapted to electrically connect with a USB 3 host controller of a host computer, the upstream USB 3 port having a USB 3 maximum data rate;
a plurality of downstream USB 2 ports adapted to electrically connect with a plurality of USB 2 peripherals;
control circuitry that (i) performs translation between USB 2 communications of the plurality of downstream USB 2 ports and USB 3 SuperSpeed communications of the upstream USB 3 port; and (ii) modifies apportionment of the USB 3 maximum data rate among the plurality of downstream USB 2 ports, such that the plurality of downstream USB 2 ports communicate at a collective data rate exceeding a USB 2 maximum data rate of USB High Speed.

2. The apparatus of claim 1, wherein the apparatus violates a USB specification, in that in the apparatus the plurality of downstream USB 2 ports communicate at the collective data rate exceeding the USB 2 maximum data rate of USB High Speed, despite the USB specification requiring that a USB specification-compliant USB 3 device has the plurality of downstream USB 2 ports communicate at the collective data rate no faster than the USB 2 maximum data rate of USB High Speed.

3. The apparatus of claim 1, wherein the apparatus violates a USB specification, in that in the apparatus the USB 2 peripherals appear as USB 3 SuperSpeed peripherals to the USB 3 host controller, despite the USB specification requiring that USB 2 peripherals appear as USB 2 peripherals to the USB 3 host controller.

4. The apparatus of claim 1, wherein said translation is transparent to the USB 3 host controller of the host computer, such that the USB 2 peripherals appear as USB 3 SuperSpeed peripherals to the USB 3 host controller and communications via the upstream USB 3 port with the plurality of USB 2 peripherals are compliant with USB 3 SuperSpeed protocol.

5. The apparatus of claim 1, wherein said translation is transparent to the USB 3 host controller of the host computer, such that the USB 3 host controller follows a USB SuperSpeed protocol to communicate with the plurality of USB 2 peripherals.

6. The apparatus of claim 1, wherein said translation is transparent to the USB 3 host controller of the host computer, such that the USB 3 host controller is unaware of whether the plurality of USB 2 peripherals communicate at USB High Speed, USB Full Speed, or USB Low Speed.

7. The apparatus of claim 1, wherein said USB 2 communications are half duplex, and USB 3 SuperSpeed communications are full duplex, such that the control circuitry performs translation between half duplex USB 2 communications and dual simplex USB 3 Superspeed communications.

8. The apparatus of claim 1, wherein the control circuitry that performs translation, creates a USB 3 SuperSpeed descriptor to represent a USB 2 peripheral connected to one of the plurality of downstream USB 2 ports.

9. The apparatus of claim 1, wherein the control circuitry that performs translation, creates a virtual USB 3 SuperSpeed device to represent a USB 2 peripheral connected to one of the plurality of downstream USB 2 ports.

10. The apparatus of claim 1, wherein the control circuitry that performs translation, creates a virtual USB 3 SuperSpeed device to represent a USB 2 peripheral connected to one of the plurality of downstream USB 2 ports, and the apparatus further includes:
a buffer that stores data transferred between the virtual USB 3 SuperSpeed device and the USB 2 peripheral.

11. The apparatus of claim 1, wherein the control circuitry that performs translation, creates a virtual USB 3 SuperSpeed device to represent a USB 2 peripheral connected to one of the plurality of downstream USB 2 ports, and the apparatus handles flow control in an upstream USB 3 link and between the virtual USB 3 SuperSpeed device and the USB 2 peripheral.

12. The apparatus of claim 1, wherein the control circuitry that performs translation, creates a virtual USB 3 SuperSpeed device to represent a USB 2 peripheral connected to one of the plurality of downstream USB 2 ports, and the control circuitry adds a frame or a micro-frame to isochronous communications between the virtual USB 3 SuperSpeed device and the USB 2 peripheral.

13. The apparatus of claim 1, wherein the control circuitry that performs translation, creates a virtual USB 3 SuperSpeed device to represent a USB 2 peripheral connected to one of the plurality of downstream USB 2 ports, and the control circuitry modifies polling of the USB 2 peripheral, to permit the host computer to go to a sleep mode.

14. The apparatus of claim 1, wherein the USB intermediate device is a USB hub.

15. The apparatus of claim 1, wherein the USB intermediate device is a USB composite device.

16. The apparatus of claim 1, wherein the control circuitry modifies apportionment, by altering a priority order among the plurality of downstream USB 2 ports.

17. A method, comprising:
in a USB intermediate device, performing translation between USB 2 communications of a plurality of downstream USB 2 ports of the USB intermediate device and USB 3 SuperSpeed communications of an upstream USB 3 port of the USB intermediate device;
in the USB intermediate device, modifying apportionment of a USB 3 maximum data rate of the upstream USB 3 port among the plurality of downstream USB 2 ports, such that the plurality of downstream USB 2 ports communicate at a collective data rate exceeding a USB 2 maximum data rate of USB High Speed.

18. An apparatus, comprising:
a USB intermediate device, including:
an upstream USB 3 port adapted to electrically connect with a USB 3 host controller of a host computer, the upstream USB 3 port having a USB 3 maximum data rate;
a plurality of downstream USB 2 ports adapted to electrically connect with a plurality of USB 2 peripherals;
control circuitry that (i) performs translation between USB 2 communications of the plurality of downstream USB 2 ports and USB 3 SuperSpeed communications of the upstream USB 3 port; and (ii) modifies apportionment of the USB 3 maximum data rate among the plurality of downstream USB 2 ports, such that the plurality of downstream USB 2 ports communicate at a collective data rate exceeding a USB 2 maximum data rate of USB High Speed; and
the host computer including the USB 3 host controller.

19. The apparatus of claim 18, wherein said translation is transparent to the USB 3 host controller of the host computer, such that the USB 2 peripherals appear as USB 3 SuperSpeed peripherals to the USB 3 host controller and communications via the upstream USB 3 port with the plurality of USB 2 peripherals are compliant with USB 3 SuperSpeed protocol, and
wherein the host computer includes code that makes the USB 3 SuperSpeed peripherals appear as USB 2 peripherals.

20. A non-transitory computer readable medium with instructions executable by a USB intermediate device including an upstream USB 3 port and a plurality of downstream USB 2 ports, the upstream USB 3 port adapted to electrically connect with a USB 3 host controller of a host computer and the plurality of downstream USB 2 ports adapted to electrically connect with a plurality of USB 2 peripherals, the instructions comprising:
translation instructions between USB 2 communications of the plurality of downstream USB 2 ports and USB 3 SuperSpeed communications of the upstream USB 3 port; and
apportionment modification instructions of a USB 3 maximum data rate of the upstream USB 3 port among the plurality of downstream USB 2 ports, such that the plurality of downstream USB 2 ports communicate at a collective data rate exceeding a USB 2 maximum data rate of USB High Speed.

21. An apparatus, comprising:
a USB intermediate device, including:
an upstream USB 3 port adapted to electrically connect with a USB 3 host controller of a host computer, the upstream USB 3 port having a USB 3 maximum data rate;
a plurality of downstream USB 2 ports adapted to electrically connect with a plurality of USB 2 peripherals;
control circuitry that performs translation between USB 2 communications of the plurality of downstream USB 2 ports and USB 3 SuperSpeed communications of the upstream USB 3 port.

22. An apparatus, comprising:
a USB intermediate device, including:
an upstream USB 3 port adapted to electrically connect with a USB 3 host controller of a host computer, the upstream USB 3 port having a USB 3 maximum data rate;
a plurality of downstream USB 2 ports adapted to electrically connect with a plurality of USB 2 peripherals;
control circuitry that modifies apportionment of the USB 3 maximum data rate among the plurality of downstream USB 2 ports, such that the plurality of downstream USB 2 ports communicate at a collective data rate exceeding a USB 2 maximum data rate of USB High Speed.
